(19) United States
(12) Patent Application Publication
(10) Pub. No.: US 2009/0254429 A1
(43) Pub. Date: Oct. 8, 2009

(54) Placement device and method

(76) Inventors: Ofer Manor, Givat Shmuel (IL); Idan Ben Ami, Givat Shmuel (IL)

Correspondence Address: Ofer Manor;Tripleglobal, Ben Gurion 11 unit 718, Givat Shmuel, 54017, IL

(21) Appl. No.: 12/419,538

(22) Filed: Apr. 7, 2009

(30) Foreign Application Priority Data
Apr. 7, 2008 (GB) 0806168.1

(51) Int. Cl. G06Q 30/00

(52) U.S. Cl. 705/14

(57) ABSTRACT

A food placement device comprising an eating area and one or more advertising areas or flaps. The dimensions of the eating area correspond to those of a tray to be used in conjunction with the placement device. The advertising flaps are foldable with respect to the eating area.

### CROSS-REFERENCE TO RELATED APPLICATIONS

The present application claims priority from the patent application No. GB 0806168.1 filed in U.K. on 7 Apr. 2008 and entitled “Placement device and method”.

### BACKGROUND OF THE INVENTION

1. Field of the Invention

The invention relates to a food placement device, and more specifically to a placement device including advertising areas or flaps.

2. Description of Related Art Including Information

A placement device may include a sheet of paper for placing the food thereon in a restaurant, for example. It may include a sheet of paper or another disposable means.

As the customer is eating and therefore not busy with other tasks, this is a good opportunity to present him/her with various advertisements. The ads may relate to products or services offered at that location, for example new items sold in the restaurant, or they may relate to other products.

A possible problem is that the placement device may become dirty with food remains. This may not contribute to enhancing the prestige of the products being advertised, rather it may be detrimental to it.

Furthermore, transportation and storage activities may be more complicated and a expensive for a large area placement device.

### BRIEF SUMMARY OF THE INVENTION

According to the present invention, a new placement device is provided which has a larger area, with clear demarcation of the eating surface vs. the advertising area. One or more advertising areas may be used.

According to another aspect of the invention, foldable flaps are used for the advertising surfaces. This allows for more efficient transportation and storage of the devices in bulk.

Such flaps are also efficient in clearly defining the advertising areas, to distinguish from the eating surface.

### BRIEF DESCRIPTION OF THE SEVERAL VIEWS OF THE DRAWINGS

FIG. 1 illustrates a placement device with three advertising areas

FIG. 2 illustrates a placement device with one, right side advertising area

FIG. 3 illustrates a placement device with two, right and left side advertising areas

FIG. 4 illustrates another embodiment of a placement device with three advertising areas

FIG. 5 illustrates a placement device with four advertising areas

FIG. 6 illustrates an oversize placement device with three non-folding advertising areas

FIG. 7 illustrates a placement device with a prominent upright corner

FIG. 8 illustrates a placement device with foldable advertising areas or coupons

FIG. 9 illustrates a placement device having multiple stapled advertising areas

### DETAILED DESCRIPTION OF THE INVENTION

A preferred embodiment of the present invention will now be described by way of example and with reference to the accompanying drawings.

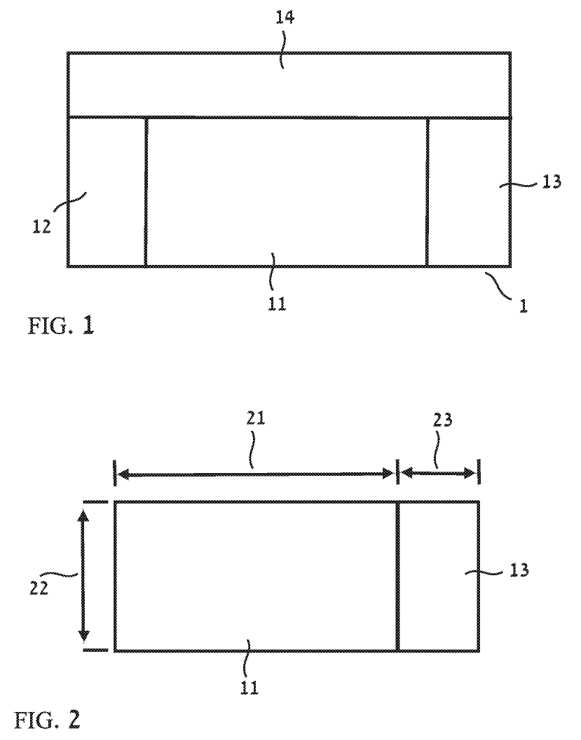

FIG. 1 illustrates a placement device 1 with an eating area 11 and three advertising areas 12, 13, 14 (left, right and upper sides, respectively).

The demarcation lines clearly indicate the eating area 11 where the food tray or the food are to be placed. Suitable instructions may be used as well. This leaves the three advertising areas 12, 13, 14 free and unobstructed, for presenting the ads printed there to the user while eating.

In one embodiment of the invention, the placement device 1 is placed on the table (not shown) with the eating area 11 so devised for placing a food tray thereon (that is, the dimensions of the area 11 correspond to those of the trays in use at that location). The area 11 is so marked that, when the food tray is placed thereon, the ads areas 12, 13 and 14 are left unobstructed to clearly and efficiently present the ads printed thereon to the user. Thus, the dimensions of the eating area 11 correspond to those of a tray (not shown) to be used in conjunction with the placement device 1.

In another embodiment of the invention, the placement device 1 is placed on the tray, with the food being placed on device 1. Again, the dimensions of the area 11 correspond to those of the trays in use at that location (the inner dimension in this case), so the ads areas 12, 13 and 14 are left outside the eating area, unobstructed to clearly and efficiently present the ads printed thereon to the user.

The lines between the eating area 11 and each of the ad areas 12, 13 and 14 indicate folding areas, so the ads areas become foldable flaps. Thus, the advertising flaps are foldable with respect to the eating area 11.

In another embodiment, the above may be perforated lines, for easy detachment of the ads areas if so desired. Thus, the demarcation between the eating area 11 and the advertising flaps may comprise perforated lines.

The lines between the ads areas 12-14 and 13-14 may indicate cut lines to separate between these areas to allow easy, independent folding of each of these ads areas, as may be desired. Thus, the demarcation between the eating area and the advertising flaps may comprise folding lines.

The same structure may be used for the lines between the areas in FIGS. 2, 3, 4 and 5.

FIG. 2 illustrates a placement device with an eating area 11 and one, right side advertising area 13.

In one embodiment, the dimensions are as follows:

width 22 of the eating and advertising areas is about 28 centimeters (cm)

length 21 of the eating area is about 37 cm

length 23 of the advertising area may be between a third of length 21 to almost equal to the length 21; half the length 21 is also a preferred value.

In another embodiment, the dimensions are as follows:

width 22 of the eating and advertising areas is about 23.5 cm

length 21 of the eating area is about 33.5 cm

length 23 of the advertising area may be between a third of length 21 to almost equal to the length 21; half the length 21 is also a preferred value.

Other dimensions may be possible, depending for example on the size of the food tray or the planned eating space at that location.

Different sizes of the eating area 11 may be used for adults and children. Moreover, different sizes of the eating area 11 may be used for breakfast or dinner, for example, or for a light meal.

When a tray is used, the dimensions may also depend on whether the placement is placed above or below the tray.

Alternately, the eating area 11 may be the size of the placement/place mat in use now (prior art device) at that location, with the advertising areas 12, 13, 14 proportionately dimensioned.

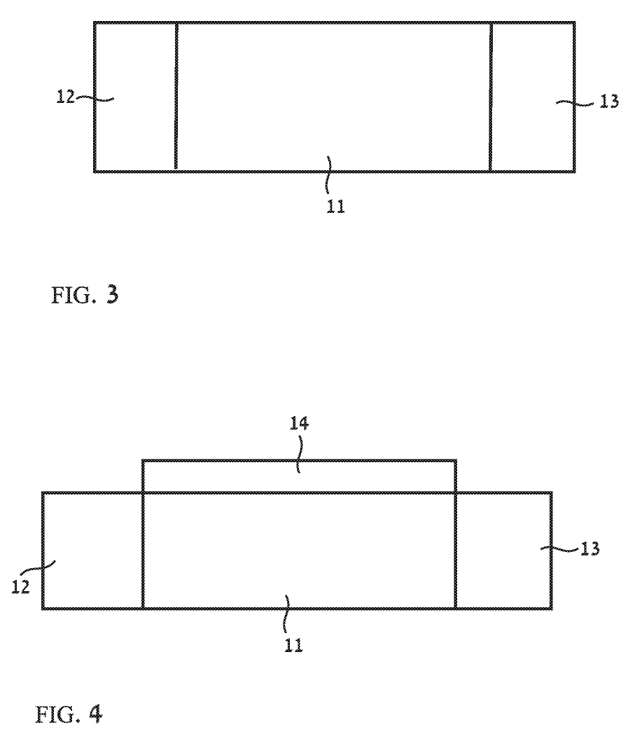

FIG. 3 illustrates a placement device with two, right and left side advertising areas 12, 13 (left and right sides, respectively) and an eating area 11.

FIG. 4 illustrates another embodiment of a placement device with three advertising areas 12, 13, 14 (left, right and upper sides, respectively) s and an eating area 11.

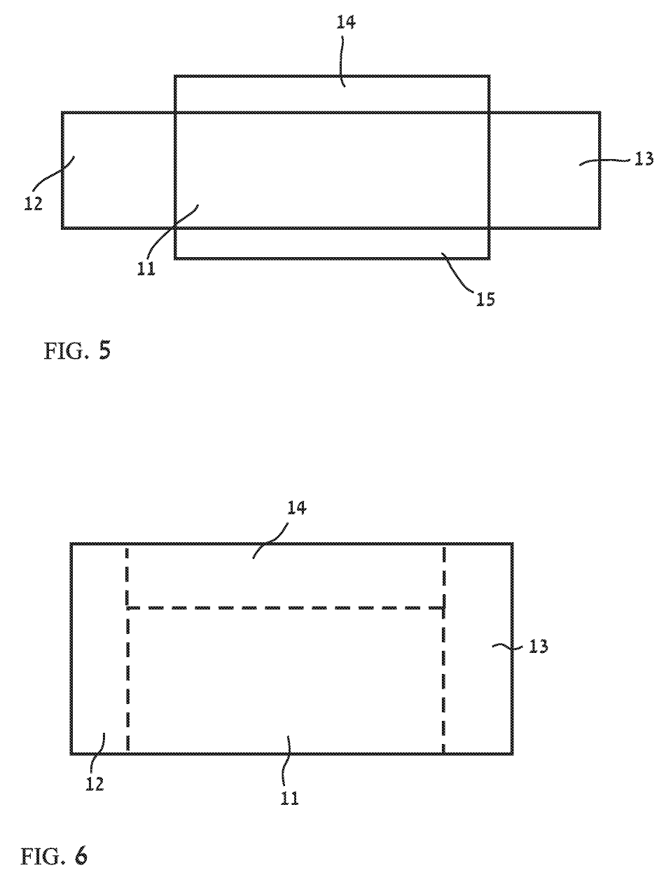

FIG. 5 illustrates a placement device with four advertising areas 12, 13, 14, 15 (left, right, upper and lower sides, respectively) and an eating area 11.

FIG. 6 illustrates an oversize placement device with three non-folding advertising areas 12, 13, 14 (left, right and upper sides, respectively) and an eating area 11.

The lines between the eating area 11 and each of the ad areas 12, 13 and 14 indicate area demarcation lines. In this embodiment, the ads areas do not become foldable flaps. Rather, one surface with clearly printed separation lines is used to define the eating and advertising areas, respectively.

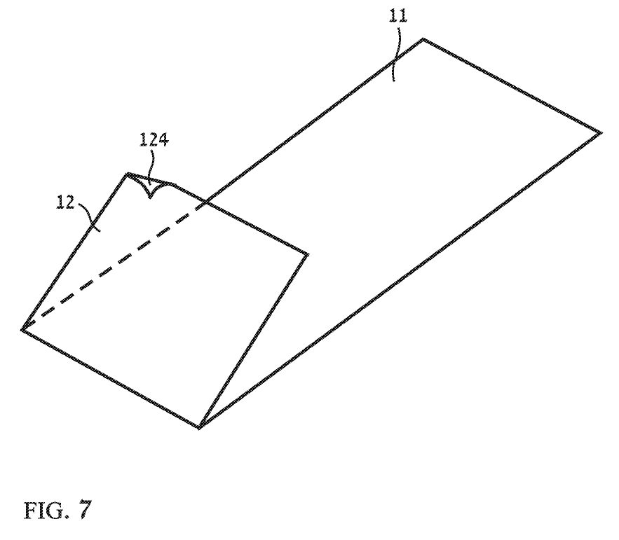

FIG. 7 illustrates a placement device with a prominent upright corner 124. The device includes an eating area 11 and a left side advertising area 12. The area 12 has an upright corner 124, to facilitate opening of the flap 12.

Various embodiments of the placement as detailed above may be implemented. Preferably, the placement 1 is made of paper. Various types of paper may be used. In another preferred embodiment, the placement 1 is made of plastic.

Preferably, the ads areas may include various ads and/or information, for example:

1. News, newspaper info

2. Ads, for that restaurant or eating place, or for other products and services.

3. Entertainment, games, puzzles, jokes.

4. Human resources info, job placement.

The above may be used in combination, for example the left side flap for jokes, the right side flap for ads, the top flap for news. There is a benefit in using a fixed, specific area for each type of message, so the user can look specifically for that which may interest him/her.

It will be recognized that the foregoing is but one example of an apparatus and method within the scope of the present invention and that various modifications will occur to those skilled in the art upon reading the disclosure set forth hereinbefore.

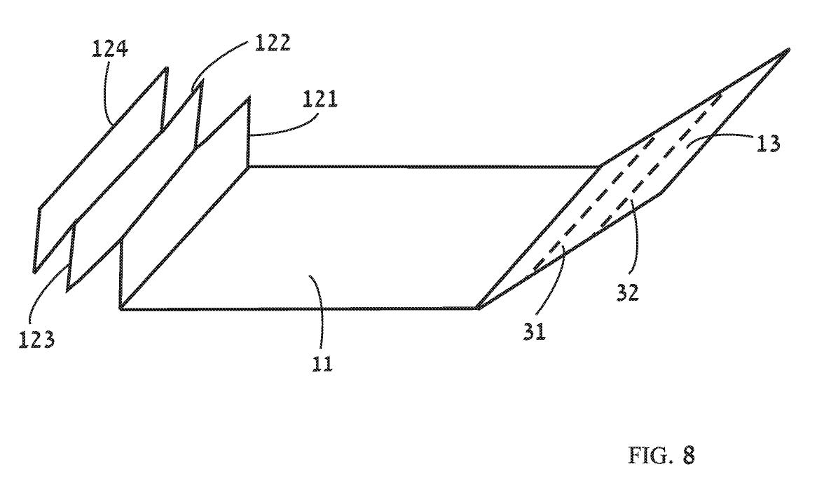

FIG. 8 illustrates a placement device 11 with foldable advertising areas 121-124 or coupons 31, 32. According to this embodiment, around the eating area 11 there can be provided one 121 or several foldable advertising areas 121-124.

These advertisements can be folded by default, so that the placement device captures minimal space of the table or the eating area. Often the user may be board or wish to read something then he can open the foldable advertising areas 121-124 and enjoy the content provided there.

The foldable advertising areas 121-124 can be related one to each other or not related—thus there can be separate adds on each of the advertising area. The advertisements can be provided on one or both sides of each advertising area.

There can be any number of foldable advertising areas 121-124, in this example there are four on one side of the eating area, however these foldable advertising areas can be provided in any number direction or combination foldable advertising areas can be provided on both sides of the eating area, having a different (or same) number of advertising areas.

The foldable advertising areas 121-124 can be provided as they are folded in a manner easy to open, such as that the area on top can be opened to the side outwards. The content on the advertising areas can be continuous, thus the order of the foldable advertising areas can be meaningful and their content can be related (as in a story).

According to this embodiment, around the eating area 11 there can be provided one or several coupons 31, 32, such as on the advertising area 13. In this example there is provided foldable advertising area on one side and coupons area on the other side, however any combination or shape may be implemented of a placement device having any number or combination of foldable area(s) and/or coupon(s) area.

In each coupon advertising area, there can be perforations between the coupons and between the inner coupon and the eating area, so that the user can easily separate one or more of them, simply by tearing them and without moving the food tray or the food placed at the eating area in case there is food thereon, thus the perforations can capture most of the length allowing easy and safe separation of the coupons.

Content upon the coupons can be provided on one or both sides of the advertising areas. The content of the coupons can be related or not between several coupons. The coupons may be related to the restaurant in which food is served or provide coupons of other services. The content and/or instructions for the coupons can also be related to the content of the foldable advertising areas 121-124, if there are such areas, and in a certain example.

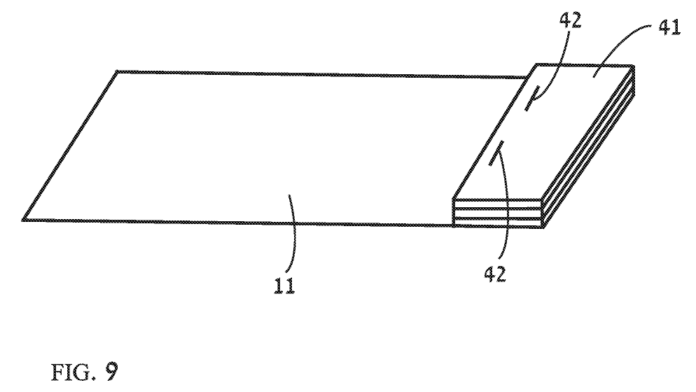

FIG. 9 illustrates a placement device with the eating area 11, having multiple stapled 42 advertising areas 41. According to this embodiment, Advertising areas can be provided as a stack of two or more stapled sheets 41. This embodiment may allow saving the table's space, reducing placement's size and easily providing an arbitrary number of advertisements. The user can tear off the sheets and any content can be provided on them. The staples 42 can be preferably small and/or provide weak grasp of the sheets 42 to allow easy separation of them. There can be provided one or more staples, placed at any location of the sheets.

The sheets can be stacked together using any other mechanism, for example they can be glued or attached to the eating area by one or more drawing pins.

In additional embodiments there can be more than one multiple stapled advertising areas in the placement, anywhere around the eating area 11.

In yet additional embodiments, there can be provided any form, manner or combination of advertising areas, including folding, non-foldable, coupons and stapled advertising areas.

What is claimed is:

1. A food placement device comprising an eating area and one or more advertising areas or flaps.

2. The food placement device according to claim 1, wherein the dimensions of the eating area correspond to those of a tray to be used in conjunction with the placement device.

3. The food placement device according to claim 1, wherein the advertising flaps are foldable with respect to the eating area.

4. The food placement device according to claim 1, wherein the demarcation between the eating area and the advertising flaps comprises folding lines.

5. The food placement device according to claim 1, wherein the demarcation between the eating area and the advertising flaps comprises perforated lines.

6. The food placement device according to claim 1, having multiple stapled advertising areas.

7. The food placement device according to claim 1, having multiple advertising areas which are attached by glue or with drawing pins.
